(19) United States
(12) Patent Application Publication
(10) Pub. No.: US 2016/0117942 A1
(43) Pub. Date: Apr. 28, 2016

(54) SYSTEMS AND METHODS FOR CAREER PREFERENCES ASSESSMENT

(71) Applicant: The Language Express, Inc., Encinitas, CA (US)

(72) Inventors: Matthew Todd Marino, Merritt Island, FL (US); Eleazar Vasquez, III, Ocoee, FL (US); Darin Edward Hughes, Winter Park, FL (US); Marc Howard Zimmerman, Encinitas, CA (US)

(21) Appl. No.: 14/979,303

(22) Filed: Dec. 22, 2015

Related U.S. Application Data
(63) Continuation of application No. 14/095,772, filed on Dec. 3, 2013.
(60) Provisional application No. 61/907,289, filed on Nov. 21, 2013.

(51) Int. Cl. G09B 7/00

(52) U.S. Cl. CPC G09B 7/00

(57) ABSTRACT

The subject matter describes systems, software, networks, platforms and methods to create one or more applications to assess an aptitude or a preference of a user, to interact dynamically with the user in a setting of a virtual task, to record and evaluate the interactions, to provide a learning platform to let the user acquire skills, and to allow teachers, parents, counselors and guardians to review the status and progress of the user.

### CROSS REFERENCE TO RELATED APPLICATIONS

This application is a continuation of U.S. application Ser. No. 14/095,772 filed Dec. 3, 2013 which claims the benefit of U.S. Application Ser. No. 61/907,289, filed Nov. 21, 2013, which is hereby incorporated by reference in its entirety.

### BACKGROUND OF THE INVENTION

The lack of an accessible, coherent career planning system has left many high school students unprepared to meet the rigorous demands associated with being college and career ready. It is estimated that approximately 7 million young people in the United States from traditionally marginalized populations (e.g., low income communities) are insufficiently prepared to make the transition from high school to postsecondary education and eventually into the workforce. School-to-work transitions are also especially difficult for students with disabilities, who comprise an additional 6.5 million K-12 students in the United States. Combined, 13.5 million young adults face a daunting future with limited opportunities for meaningful employment.

### SUMMARY OF THE INVENTION

Advantages of the subject matter described herein include a promising practice to enhance career preparation by the use of individualized learning plans (ILPs). Exploiting ILPs is a means to provide students with explicit pathways to postsecondary education and career goals. When used by high school students, ILPs are strategic planning tools to help students and families align high school coursework with career aspirations. Students of ILPs gain control of their career exploration, planning and management, and they are likely to become confident learners who regularly attend school, actively set goals, and attain higher grades. In some embodiments, the ILPs can be extended to young adults, old adults, and job seekers who can enjoy better career development provided the ILPs.

In one aspect, described herein are non-transitory, computer-readable storage media encoded with a computer program including instructions executable by a processor to create an assessment application comprising: (i) a first software module configured to evaluate an aptitude or a preference of a first user; (ii) a second software module configured to interact with the first user in a setting of a virtual task; and (iii) a third software module configured to evaluate one or more of the interactions.

In another aspect, described herein is a computer-implemented system including a digital processing device comprising an operating system configured to perform executable instructions, a memory device, and a computer program including instructions executable by the digital processing device to create an assessment application comprising: (i) a software module configured to evaluate an aptitude or a preference of a first user; (ii) a software module configured to interact with the first user in a setting of a virtual task; and (iii) a software module configured to evaluate one or more of the interactions.

In another aspect, described herein is a network including (i) a first computer terminal configured to provide an assessment application comprising: a software module configured to evaluate an aptitude or a preference of a first user, a software module configured to interact with the first user in a setting of a virtual task, and a software module configured to evaluate one or more of the interactions; (ii) a second computer terminal configured to provide a monitoring application comprising: a software module configured to review the aptitude or the preference of the first user, a software module configured to review the one or more interactions of the first user, a software module configured to review a learning progress report of the first user; (iii) a server comprising a processor configured to provide a server application comprising: software module configured to store the aptitude or the preference of the first user, software module configured to prepare the virtual task, software module configured to offer a learning platform for the first user, software module configured to record the learning progress of the first user; (iv) one or more network connections between the server and the first and the second computer terminals.

### BRIEF DESCRIPTION OF THE DRAWINGS

FIG. 1 is illustrative of a non-limiting example of a computing architecture of a system; in this case, the system was deployed in a simulated school district to allow students to use career assessment applications.

FIG. 2 is illustrative of a non-limiting example of an account setup structure; in this case, the system was deployed in a simulated school district and the user accounts were created for the district, schools, teachers, classes, and students.

FIG. 3 is illustrative of a non-limiting example of a flow chart of using a career assessment application; in this case, the flow chart indicates the steps for how a student was experiencing a virtual task in an employment.

FIG. 4 is illustrative of a non-limiting example of an assessment report; in this case, the report showed the proficiency levels.

FIG. 5 is illustrative of a non-limiting example of a decision tree in career preference assessment; in this case, the decision tree was implemented in an interactive system to guide students to reach a conclusion.

FIG. 6 is illustrative of a non-limiting example of a computer system underlying an assessment application and a monitoring application; in this case, a server-client architecture was used to host assessment application to students and monitoring application to teachers.

FIG. 7 is illustrative of a non-limiting example of a monitoring application; in this case, a monitoring application was used by “Mrs. Smith” who can review the learning progress of her students.

### DETAILED DESCRIPTION OF THE INVENTION

The lack of an accessible, coherent, career planning system has left many high school students unprepared to meet the rigorous demands associated with being college and career ready. It has been estimated that approximately 7 million young people in the United States from traditionally marginalized populations (e.g., low income communities) are insufficiently prepared to make the transition from high school to postsecondary education and eventually into the workforce. School-to-work transitions are also especially difficult for students with disabilities, who comprise an additional 6.5 million K-12 students. It is believed that the combined 13.5 million young adults in the United States face a daunting future with limited opportunities for meaningful employment. As a result, a new method is desired to support their career readiness.

Advantages of the subject matter described herein include a promising practice to enhance career preparation by the use of individualized learning plans (ILPs). Exploiting ILPs is a means to provide students with explicit pathways to postsecondary education and career goals. When used by high school students, ILPs are strategic planning tools to help students and families align high school coursework with career and post-secondary aspirations. Students of ILPs gain control of their career exploration, planning and management, and they are likely to become confident learners who regularly attend school, actively set goals, and attain higher grades. In some embodiments, the ILPs can be extended to young adults, old adults, and job seekers who can enjoy better career development provided the ILPs.

The benefits of the subject matter described herein include: increased perceptions of the relevance of education in users' lives; users selecting a course of study aligning with career goals; more rigorous course selection. In some embodiments where the subject matter described herein is deployed in schools and homes, communication between teachers and parents can be greatly enhanced. The postsecondary and workforce readiness can be increased by strategically linking a dynamic virtual career preference assessment and subsequent “day in the life” of multiple career professions. While implemented in a modern wireless network, the software, systems, networks, platform and methods disclosed herein can assist students or users to complete ILPs using mobile devices at their convenience. The alignment of user choice during the career assessment with authentic virtual workplace experiences provides a unique opportunity for users to learn both social and career specific knowledge, vocabulary and skills.

The subject matter described herein utilizes a participatory design model, which may lead to a salient, cost effective career development system, software and platform that change the way schools prepare our young people to compete in the twenty-first Century workplace. The media, systems, networks, platforms, and methods described herein offer adolescents and young adults with a career preference assessment and employment training. Participants will experience a day in the life of their preferred careers with opportunities to practice daily living skills, social skills, and career specific tasks. The outcomes of the experience for students may be: identification of preferred employment; strategic alignment of career training with sixteen career clusters identified by the National Association of State Directors of Career Technical Education; virtual job shadowing experiences within preferred careers; extended practice opportunities with the knowledge, skills, and vocabulary needed to actively participate in the career; a dynamic portfolio of virtual experiences that generate a customized resume; an individualized learning plan that provides a roadmap to the intended career path.

Teachers, parents, and members of a transition planning team using the media, systems, networks, platforms, and methods described herein can also benefit from: research-based instructional strategies; easy to understand transition planning assessment data; lower cost for career exploration; reduced reliance on transportation and supervision funding to provide extended field placements; career experiences in a safe, nonthreatening environment.

The subject matter described herein can improve users' engagement and learning. Assessment outcomes for transition/career planning can become more accurate. Users of assessment software can gain social skills and enhance effectiveness of job shadowing. The media, systems, networks, platforms, and methods described herein can change current practices by engaging students in secondary educational courses before they become disenfranchised with employment or postsecondary education.

Schools are usually the first place to help students evaluate their career preferences. Table 1 contrasts the traditional approaches with the subject matter described herein. In general, there are five domains to assess career preferences: job search skills, adolescent development, career and work-readiness skills, work-based learning, and financial literacy. Each domain is associated with one or multiple questions. The responses provided by students or job seekers are collected to evaluate the aptitude, preferences, and skill levels. Traditionally, response collection and preference assessment are largely human-based, mostly done by counselors. The human-assisted career preference assessment is time consuming, and its effectiveness is limited. The subject matter described herein utilizes computer-mediated assessment to immerse students in a realistic virtual world where a personal learning assistant (i.e., similar to a big brother or big sister) guides the student through the career search process during a daily living skills game. Each search is individualized based on a virtual career preference assessment, the student's location, resume, job experience, and career aspirations. In some embodiments, students participate in a series of video games related to their daily living skills (e.g., morning routine, transportation, leisure, exercise) to learn which jobs fit their lifestyle choices. The games reinforce best practice lifestyle decisions, as guided by the National Institutes of Health. In some examples, students obtain credits for healthy eating and not smoking. Unlike the traditional career preparation, the computer-mediated assessment conveys information using multiple modalities (i.e., virtual objects, texts, audios, and videos), making it accessible for traditionally marginalized populations such as English language learners, students with disabilities, etc.

TABLE 1
Virtual career planning using the subject matter described herein.

| | Critical | | |
|---|---|---|---|
| Domain | questions | Traditional approach | Subject matter described herein |
| Job search | What are my | Guidance counselors | Students are immersed in a realistic virtual world where a |
| skills | career | provide newspapers or | personal learning assistant (i.e., similar to a big brother or big |
| | options? | websites where | sister) guides the student through the career search process during |
| | | students can read | a daily living skills game. Each search is individualized based on |
| | | through job postings. | a virtual career preference assessment, the student's location, |
| | | | resume, job experience, and career aspirations. |
| Adolescent | Who am I? | Guidance counselors | Students participate in a series of videogames related to their |
| development | What is the | provide self-awareness | daily living skills (e.g., morning routine, transportation, leisure, |
| | best job for | paper and pencil | exercise) to learn which jobs fit their lifestyle choices. The games |
| | me? | worksheets such as the | reinforce best lifestyle decisions, as guided by the National |
| | | “Career Planning | Institutes of Health. For example, students obtain credits for |
| | | Scale” or access to | healthy eating and not smoking. Unlike the traditional career |
| | | text-dense websites. | preparation, the system conveys information using multiple |
| | | | modalities (i.e., virtual objects, audio, video) with limited |
| | | | reliance on text, making it accessible for traditionally |
| | | | marginalized populations such as English language learners, |
| | | | students with disabilities, etc. |
| Career and | What is the | Limited and variable: | Students play through a realistic “day in the life” of a person in a |
| work- | plan? | Some schools offer a 1 | series of careers of their choice. They are provided with a virtual |
| readiness | How do I | credit, 1 semester | mentor who critiques the student's in-game choices and provides |
| skills | get the job? | elective course to | exemplary behaviors related to soft skills that are necessary in the |
| | How should | address this broad | workplace. The mentor also tells a back story of his or her |
| | I prepare for | domain. Lessons are | education including college or technical training that was |
| | work? What | often limited. | necessary to obtain the job. As the virtual mentor describes these |
| | soft skills do | | experiences, the student has the option to be virtually transported |
| | I need? | | to this new location (e.g., a community college campus) and play |
| | | | out the education experience, including dorm life, study skills, |
| | | | etc. These experiences inform the students' career decisions and |
| | | | preparation. |
| Work- | What is the | Extremely limited | As students play through the “day in the life” games the virtual |
| based | culture at | availability. This | mentor explains subtle cues (e.g., furniture in the office, |
| learning | my | usually occurs in entry | interactions in the hallway) and how those assist to interpret the |
| | workplace? | level positions during | culture. The mentor coaches the student to make choices that will |
| | What are my | after school | lead to career advancement and explains the hierarchy of jobs |
| | roles and | employment | within the chosen career. |
| | responsibilities? | | |
| | How do I | | |
| | advance in | | |
| | my career? | | |
| Financial | What should | Available as an option | The software and system provide financial advice and positive |
| literacy | I do with my | in some family & | reinforcement throughout the daily living skills games, modeling |
| | paycheck? | consumer sciences | exemplary fiscal management and reinforcing decisions that have |
| | How do I | (e.g., home | a high likelihood of financial stability. The system will also |
| | save for the | economics) courses. | provide links to potential funding sources (e.g., financial aid for |
| | future? | | college) and exemplar applications. Finally, the software and |
| | How do I | | system will identify and explain core financial principles such as |
| | manage my | | compounding interest. |
| | assets? | | |

The benefits of the subject matter described herein include, but not limited to, (1) assessing users' work-related values; (2) researching and choosing a major of interest in college; (3) searching occupations based on users' aptitude, values, interests, personality and/or work skills; (4) receiving the latest information regarding college and employment opportunities; (5) connecting users directly to institutions and/or to application processes; (6) deciding education and training requirements for each occupation; (7) making a career development plan; and (8) connecting users directly to potential employers by matching skills, education, and/or other qualifications to organizations which seek similar qualified individuals.

In some embodiments, students play through a simulated “day in the life” of a person in a series of careers of their choice. They are provided with a virtual mentor who judges the student's in-game choices and provides exemplary behaviors related to soft skills that are necessary in the workplace. The mentor also tells a back story of his or her education including college or technical training that was necessary to obtain the job. As the virtual mentor describes these experiences, the students have the option to be virtually transported to this new location (e.g., a community college campus) and play out the education experience, including dorm life, study skills, etc. These experiences inform the students' career decisions and preparation. As students play through the “day in the life” games the virtual mentor explains subtle cues (e.g., furniture in the office, interactions in the hallway) and how those assist to interpret the culture. The mentor coaches the students to make choices that will lead to career advancement and explains the hierarchy of jobs within the chosen career.

In some embodiments, the subject matter described herein develops a system to provide financial advice through games of practicing daily living skills, modeling exemplary fiscal management and reinforcing monetary decisions that have a high likelihood of financial stability.

Described herein, in certain embodiments, are non-transitory, computer-readable storage media, encoded with a computer program, including instructions executable by a processor to create an assessment application comprising: (i) a first software module configured to evaluate an aptitude or a preference of a first user; (ii) a second software module configured to interact with the first user in a setting of a virtual task; and (iii) a third software module configured to evaluate one or more of the interactions taking place in the second software module.

Also described herein, in certain embodiments, is a computer-implemented system, including a digital processing device, comprising an operating system configured to perform executable instructions and a memory device, and a computer program including instructions executable by the digital processing device to create an assessment application comprising: (i) a software module configured to evaluate an aptitude or a preference of a first user; (ii) a software module configured to interact with the first user in a setting of a virtual task; and (iii) a software module configured to evaluate one or more of the interactions.

Also described herein, in certain embodiments, is a network including (i) a first computer terminal configured to provide an assessment application comprising: a software module configured to evaluate an aptitude or a preference of a first user, a software module configured to interact with the first user in a setting of a virtual task, and a software module configured to evaluate one or more of the interactions; (ii) a second computer terminal configured to provide a monitoring application comprising: a software module configured to review the aptitude or the preference of the first user, a software module configured to review the one or more interactions of the first user, a software module configured to review a learning progress report of the first user; (iii) a server comprising a processor configured to provide a server application comprising: software module configured to store the aptitude or the preference of the first user, software module configured to prepare the virtual task, software module configured to offer a learning platform for the first user, software module configured to record the learning progress of the first user; (iv) one or more network connections between the server and the first and the second computer terminals.

Also described herein, in certain embodiments, is a system that is configured to provide subject matter described herein, for example, as shown in Table 1.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Aptitude and Preference

In some embodiments, the media, systems, networks, platforms, and methods described herein include an assessment application to evaluate the aptitude and preference of a user. The aptitude may be career aptitude, and the preference may be career preference. In other embodiments, the evaluation of the aptitudes and preferences is conducted by aptitude tests, surveys, or the like. In certain embodiments, the users of the assessment application are students. In some cases, the users are young adults or old adults. Alternatively, the users may be job seekers, children, teenagers, or any people who want to assess their own career preferences.

### Evaluation of Career Skills

The subject matter described herein utilizes modern technologies to assess skills for career development. In some embodiments, the media, systems, networks, platforms, and methods described herein include a software module to interact with a user in a setting of a virtual task. In some embodiments, the virtual task is determined based on the aptitude or the preference of the user. The virtual task may be a task designed to prepare the user for an employment. In some embodiments, the software module interacting with the user comprises a survey, so the software module can document the skills the user already possesses and the skills the user desires to acquire. In certain embodiments, the software module interacting with the user comprises a game allowing the user to play a role, and the software module records the responses and actions for further career preference analysis. In some embodiments, the software module is implemented as a video game. In further embodiments, the user plays the game with, by way of non-limiting examples, wearable electronic devices with sensors, mobile devices, or tracking technologies, so the software module can sense and record the actions taken by the user. In some embodiments, the software module creates one or more virtual mentors to assist the game play and training. Alternatively, the virtual mentors can assist the use of complex system features (e.g., navigating in a construction site) and can guide the use of job specific skills, such as virtual laboratory equipment.

The analysis of the interactions may include recording all, or part of, the interactions made by the user. In some embodiments, the analysis evaluates the appropriateness of the interactions performed by the user in the virtual task. Suitable analyses of appropriateness comprise statistical methods. By way of non-limiting examples, statistical analysis includes estimation, prediction, and/or inference. Alternatively, the analysis of appropriateness may utilize sophisticated computational models in the field of, by way of non-limiting examples, artificial intelligence, machine learning, and expert systems.

### College Choice Preference

In some embodiments, the media, systems, networks, platforms, and methods described herein include a software module to evaluate a college choice inclination for the user. Evaluating the college choice may comprise analyzing the aptitude or the preference of the user. In some embodiments, evaluating the college choice is based on analyzing the interactions performed by the user in the virtual task. In some embodiments, evaluating the college choice is based on analyzing demographic information of the user, by way of non-limiting examples, such as age, race, city, languages spoken, tuition budget, financial aid, household income, and geographic preference. Alternatively, evaluating the college choice may comprise a survey which inquires, by way of non-limiting examples, education history, work experiences, projects experiences, language skills, writing samples, college style preferences, college location preferences, college major preference, and/or technical skills. The college choice may be a discipline in, by way of non-limiting examples, sports, arts, natural sciences, social sciences, languages, engineering, business management, technologies, techniques, design, music, health care, paralegal, or a combination of the same. The user may be provided specific college information, external links, or other contact details required to apply to a designated educational institution.

### Career Suggestions

In some embodiments, the media, systems, networks, platforms, and methods described herein include a software module to generate an assessment report to the user. The report may make personalized career suggestions. In further embodiments, the assessment software further comprises a module to draft a resume for the user. In other embodiments, the assessment software further comprises a module to suggest a career path to the user. In some cases, the assessment software generates suggested high school coursework that is necessary for career entry. In some embodiments, the assessment software further comprises a module to suggest one or more educational institutions to the user. The educational institutions may be, by way of non-limiting examples, universities, colleges, vocational schools, and training centers.

In some embodiments, the assessment application further comprises a module to suggest one or more potential employers to the user. In further embodiments, the assessment application comprises a module to offer a mock job interview. The mock job interview may comprise dynamic or adaptive interactions with the user.

### Use of Posture/Gesture Tracking

In some embodiments, the media, systems, networks, platforms, and methods described herein include a software module to utilize tracking technologies, by way of non-limiting examples, e.g., wearable electronics devices, mobile devices with sensors, and the Microsoft® Kinect®, to register and recognize body postures, gestures, and facial expressions. In further embodiments, the software module creates a simulated scenario and records the responses of the user. The software module may further provide a feedback mechanism for the training of social interactions.

Alternatively, the software module may be used in the virtual task to track the responses of the user. In some cases, the software module is used in the mock interview to capture body language. By registering and recognizing body languages in a known context, the simulation can provide detailed after-action review as well as real-time responses. Exploiting the posture/gesture tracking technologies, the user can review the inappropriate body language that was unconsciously presented. Taking the advantage of such a reviewing process may dramatically improve the user's performance in employment tasks and job interviews.

### Learning Platform

In some embodiments, the media, systems, networks, platforms, and methods described herein include a software module to provide the user with a learning platform. In some embodiments, the learning platform introduces one or more employments to the user. The employments may be manually entered by the user, or selected by the user from a list. Alternatively, the employments may be automatically selected based on the aptitude or the preference of the user, based on a career skill evaluation of the user, based on a college choice preference of the user, and/or based an assessment report of the user.

In some embodiments, the learning platform comprises instructions or courses teaching the user one or more skills to complete a task in an employment. In some embodiments, the courses are presented after the user completes the evaluation of career skills in a virtual task, and the courses teach the skills required in the virtual task. Alternatively, the courses are presented before the user completes the evaluation of career skills in a virtual task, and the career skill evaluation serves a tool to examine the learning progress. The course materials described herein may be prepared in the format of texts, images, videos, audios, or a combination of the same.

In some embodiments, the learning platform evaluates the effectiveness of the learning. The learning platform may comprise an exam to evaluate skills learned by the user. On the other hand, the learning platform may create a virtual task where the user interacts with the software, and it assesses the learning effectiveness of the user. In some embodiments, the learning platform generates a learning progress report or feedback to the user.

### Monitoring Application

In some embodiments, the media, systems, networks, platforms, and methods described herein include a monitoring application to monitor the status of children or teens. The users of the monitoring application may be, by way of non-limiting examples, teachers, parents, counselors, or staff members of training/career centers. The user of the monitoring application may review aptitudes/preferences, the interactions in the virtual task, assessment reports, and/or learning progresses of one or more users of the assessment application.

### Digital Processing Device

In some embodiments, the media, systems, networks, platforms, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected to a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In certain embodiments, the display is a holographic display. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video/infrared camera, or an array of infrared/video cameras to capture motion or visual input. In other embodiments, the input device is a magnetic, acoustic, or light-based sensor enabling the tracking of various kinds of motion and user articulations. In still further embodiments, the input device is a combination of devices such as those disclosed herein.

### Non-Transitory Computer Readable Storage Medium

In some embodiments, the media, systems, networks, platforms, and methods described herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the media, systems, networks, platforms, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable, complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the media, systems, networks, platforms, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the media, systems, networks, platforms, and methods disclosed herein include one or more databases, or use of the same. In view of the disclosure provided herein, those of skill in the art will recognize that many databases are suitable for storage and retrieval of career assessment information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, networks, platforms, and methods described herein and are not meant to be limiting in any way.

### Example 1

### System Architecture

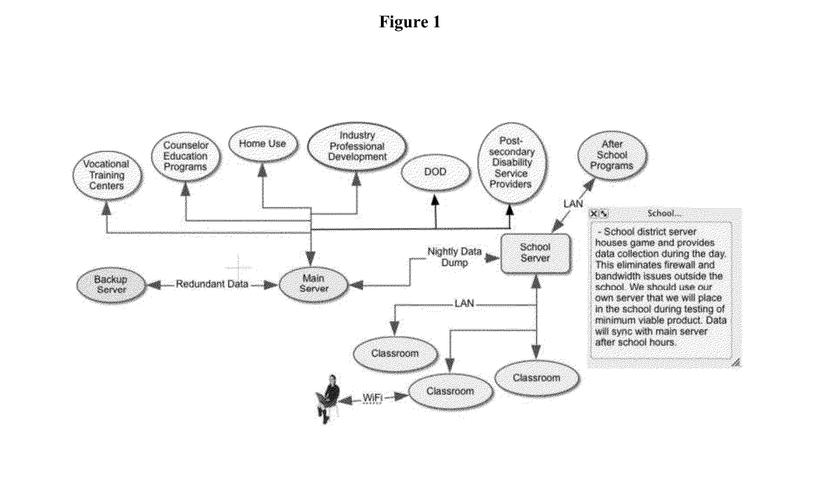

FIG. 1 shows a non-limiting example of a system design. The subject matter described herein was deployed in a confidential, simulated school district. The school server hosted the assessment application and monitoring application. Students used their mobile devices or wired computing devices in the classroom to receive career preference assessment. The data stored in the school server was also synchronized with the main server, which allowed the students to access the applications when they are away from schools. On the other hand, joining in the network were third party institutions, such as vocational training centers, counselor education programs, parents, industry professional development centers, and post-secondary disability service providers. The third parties provided career related information online, such as courses, skills training, career counseling, and recruiting events.

### Example 2

### Establish User Accounts

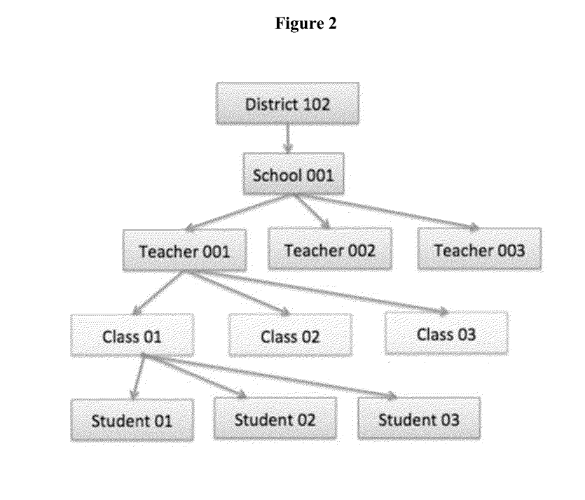

FIG. 2 shows a non-limiting example of account setup when the subject matter described herein was deployed in a confidential, simulated school district. The account levels were divided into three tiers: Level 1 Users (fee-based), who were system administrators able to access system level information, choose game level paths (incremental, random, or selected), and run analytic reports based on all system independent and dependent variables; Level 2 Users, who were parents, teacher, guardian, guidance counselor; Level 3 Users, who were high school students.

A level 2 user entered the physical address of the school or home. The system populated a school-level data questionnaire, which the user was asked to confirm or alter. Table 2 shows variables in the questionnaire regarding school information. The teacher then established his/her personal account. Table 3 shows another questionnaire with variables for the teacher to complete. The level 2 user is now ready to set up student accounts in the teacher dashboard.

TABLE 2
School data

| | Teacher | Automatically populated |
|---|---|---|
| Variables | Report | based on user's Zip code |
| Community population | | |
| Median income | | |
| School population | | |
| Free/reduced lunch rate | | |
| Racial distribution | | |
| School English language | | |
| learner % rate | | |
| School special education % rate | | |
| School college attendance rate | | |
| Dropout rate | | |
| School rating (based on National | | |
| Assessment of Educational Progress | | |
| scores) | | |
| Map location | | |
| Desktop download speed | | |

Next, the teacher established student accounts. A student account can be initiated from the student, or from a teacher through a dashboard control panel. The student session began with the student (i.e., level 3 user) entering his or her birthday and creating a unique login and password. If the student was under age 18 he or she must enter an email address of a teacher, parent or guardian (i.e., level 2 user). When a new student account was created, the level 2 user associated with the account received an email asking if he/she can authorize the account creation. To finalize account creation, the level 2 user clicked a confirmation link in the email. Clicking the link generated a code by which all student information started being tracked. This code allowed anonymous data collection, yet still provided enough structure for the teachers and researchers to know the level 2 user it originated from. The level 3 user code used by the system followed the structure XXX-XXX-XXX-XX-XX, where the first three numbers indicated the district, second three the school, third the teacher, fourth the class, and fifth the student. The teacher and student did not need to remember this code. It was used for tracking purposes only. For example, code 002 (Orange County, Fla.)—016 (Harbor Middle)—984 (Mrs. Jones)—01 (Mrs. Jones 1st class)—01 (first student account for Mrs. Jones in class 1). This number was stored in the system and tagged to the teacher account. The teacher received an email with the student's number, username, and password. The student account then populated to the teacher dashboard. The teacher clicked on the student account in his/her dashboard and completed a checkbox questionnaire about the student to finalize account generation. Questions regarding students were based on data in Table 4. The teacher could also upload a picture of the student. To finish the level 3 user account generation, the student completed a questionnaire with data from Table 5. The student was then ready to complete the career preference assessment.

TABLE 3
Teacher data (self-report)

| Variables | Variables | Variables |
|---|---|---|
| Teacher ID (system generated) | Certifications | Tech proficiency (Likert) |
| Username | Years teaching | Mobile devices in classroom |
| Password | Content areas taught | Desktop download speed |
| Gender | # of classes taught per day | # of Desktop & Laptop computers in |
| | | classroom |
| Race | Average class size | Ratio of students to technology |
| | | (computers and mobile devices) |
| Age | Classroom demographics | Highest degree |
| Degree area(s) | Knowledge of universal | Professional development hours per year |
| | design for learning | |
| Current transition/career | Last tech professional | Knowledge of transition planning |
| preparation practices | development | |

TABLE 4
Background student data

| | Teacher Entered from Individual |
|---|---|
| Student Entered | Education Plans when applicable |
| Username (temporary) | Disability status |
| Password (temporary) | Disability category |
| ID Number (XXX-XXX-XXX-XX-XX) | NAEP Reading, math, science |
| Age | Age |
| Race | Race |
| Grade | Grade |
| Gender | Gender |
| Teacher email | |
| Tech proficiency (Likert) | |
| Primary language | |
| Mobile device at home | |
| Personal mobile device (yes/no) | |
| Preferred learning method (Direct | |
| Instruction, guided discovery, | |
| Problem-based learning, | |
| social constructivism) | |
| Hours per week playing video games | |
| Hours per week watching TV | |
| Preferred assessment method (test, | |
| project, lab, video game, other) | |
| Career aspirations | |
| Content specific self-efficacy (Likert) | |
| Self-determination (Likert) | |

TABLE 5
Career assessment setting

| | |
|---|---|
| Avatar/gender | Background sound volume |
| Skin | Game speed (slider) |
| Text size | Controller Sensitivity Setting |
| Text-to-speech (on/off) | Speech-to-text |
| Expert guidance sound volume | Alternate Keyboard |

### Example 3

### Use of the Assessment Application

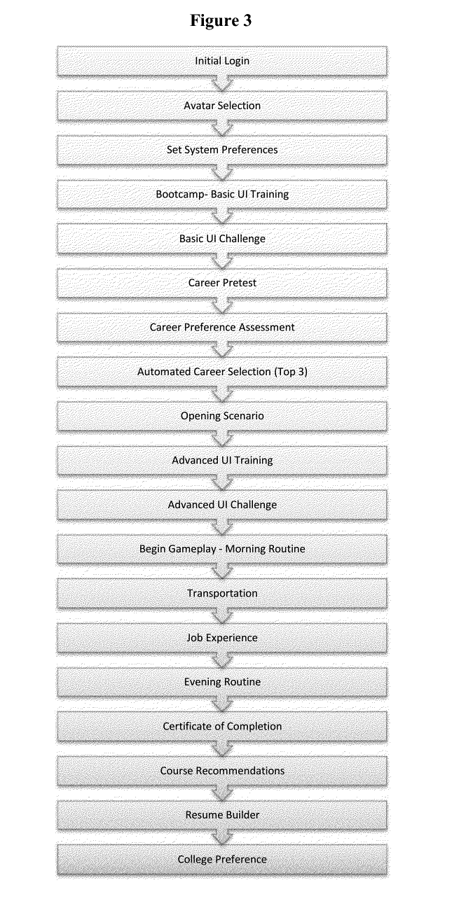

FIG. 3 shows a non-limiting example of a flow chart of using a career assessment application. Once a student's account was populated and the initial login was complete, the student selected an avatar and set the preferences described in Table 6. These can be changed at any time. The student then viewed a training module that explained basic system features such as how to open and close windows, get help, and navigate via the avatar. The student then was challenged to complete the tasks described in the training. The student must reach a minimum default proficiency level of 80% to move to the next level. The teacher could adjust the minimum proficiency level for each student using a Teacher Dashboard.

TABLE 6
Student gameplay setting

| | |
|---|---|
| Boot camp proficiency attempts & outcomes | Help toggles (agent request) |
| Advanced User Interface proficiency | Game speed adjustment |
| attempts & outcomes | |
| Play time (total) | Objectives completed |
| Play time per level | Skills demonstrated |
| Levels attempted | Resume output |
| Levels completed | |

Next the student responded to a brief series of text questions (with read aloud option) related to career aspirations, self-determination, and self-efficacy across content areas. These were used to establish career readiness baseline data. The student then participated in the career preference assessment. The student made a series of choices by interacting in a dynamic virtual learning environment with avatars engaging in tasks he/she may enjoy. The system used a weighted algorithm based on student inputs to generate 3 potential career pathways for the student.

The student then watched a 90-second video/animation opening scenario that established the context for the next series of games, where the student must carry out tasks associated with their potential careers. After watching the opening scenario, which can be viewed multiple times if necessary, the student received an advanced training in the new game environment. The system came with two types of mentors for gameplay and training. The first type of mentor was a Career Virtual Mentor. All career training was led by a Career Virtual Mentor. Tasks included guiding the use of complex system features (e.g., navigating in a construction site) and the use of job specific skills, such as virtual laboratory equipment.

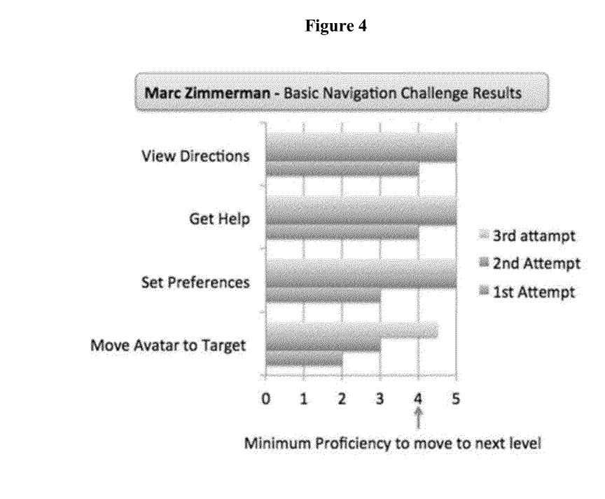

Following the animated training, the student completed a series of challenges in the game to demonstrate game mechanics proficiency. FIG. 4 shows a proficiency report of a student. Default proficiency was set at 80%, but it could be altered by the teacher as described above. The student had unlimited attempts to meet the 80% criteria. The Career Virtual Mentor provided assistance if the student needed it for job specific questions or problems. The second type of mentor was a Peer Virtual Mentor. The Peer Virtual Mentor was a peer 5-10 years older than the student who currently exhibited interests in employment and daily living skills. The Peer Virtual Mentor provided assistance if the student needed it during daily living skills (e.g., morning routine, leisure activities, etc.) gameplay.

### Example 4

### Dynamic In-Game Career Preference Assessment

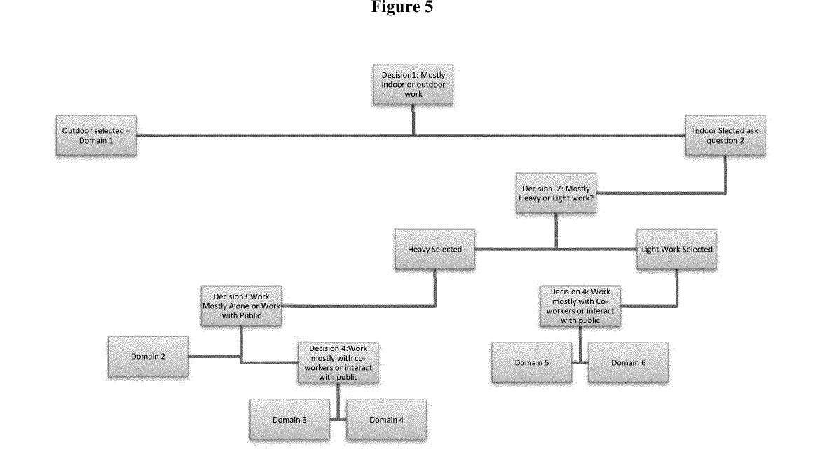

This example shows a non-limiting example of game-based assessment of career preference. FIG. 5 shows a decision tree embedded in a system with a virtual gameplay environment to allow dynamic in-game choices. Career choices were then represented by avatars within the virtual environment. These avatars can be found throughout the environment in positions (e.g. indoor, outdoor, etc.) and performing tasks that reflected a particular career. The user may interact with these avatars, view the kinds of work that they do, be transported to similar careers represented by other avatars, or opt to disengage and terminate the selected career path. These interactions were recorded by the system and formed a dynamic database about the user's preferences. Through free-play and exploration, a profile was formed over time and iteratively refined to create a comprehensive preference assessment. Once a complete profile has been formed, the user can interview for a position in their career path.

Tables 7-12 display various types of job examples encoded in the database. The characteristics required by each job were stored in the database. When the students' features were identified through in-game assessments, the suitable job types were presented to the students.

TABLE 7
Mostly Outdoors job examples

| | | |
|---|---|---|
| Grain Farmer | Amusement Park Worker | Nursery Worker |
| Asphalt Paver | House Painter | Boat Repairer |
| Brick Mason | Carpenter | Messenger |
| Forest Worker | Airport Utility Worker | Mechanic |
| Equipment Operator | Able Seaman | Utility Cable Worker |
| Gardener | Logger | Dairy Farmer |
| Mail Carrier | Dock Worker | Plumber |
| Garbage/Recycling | | |
| Collector | | |

TABLE 8
Mostly Indoors/Heavy Work/Mostly Alone job examples

| | | |
|---|---|---|
| Upholstery Worker | Carpet Cleaner | Insulation Worker |
| Janitor | Building Painter | Hotel Housekeeper |
| Electrician | Cutting Machine Operator | Painter |
| Dry Cleaner | Welder | Plumber |
| Auto Mechanic | Grocery Stocker | Sheet Metal Worker |
| Slot Machine Repairer | Woodshop Assistant | Fabricator |
| Domestic Housekeeper | Shop Painter | Sewing Machine |
| Laundry Worker | Operator | |

TABLE 9
Mostly Indoors/Heavy Work/Mostly
with Co-Workers job examples

| | | |
|---|---|---|
| Hand Packer | Machinery Maintenance | Auto Body Repairer |
| Machinist | Worker | Tool and Die Maker |
| Auto Detailer | Food Preparation Worker | Network Administrator |
| Heating/Air | Veterinary Assistant | Furniture Mover |
| Conditioning | Fast Food Cook | Print Press Machine |
| Mechanic | Farm Equipment Mechanic | Operator |
| Video Assistant | Department Store Clerk | Market research |
| Fire Station | Warehouse Worker | analyst |
| Attendant | | Shipping and |
| Restaurant Cook | | Receiving |
| Butcher | | Worker |

TABLE 10
Mostly Indoors/Heavy Work/Interact with Public job examples

| | | |
|---|---|---|
| Child Care Worker | Dining Room Attendant | Driver/Sales Worker |
| Home Health Aide | Baker | Baggage Porter |
| Occupational Therapist | Copy Center Worker | Civil engineer |
| Assistant | Grocery Clerk/Bagger | Recreation Assistant |
| Fast Food Cashier | Grocery Cashier | Arcade Worker |
| Personal Care Aide | Waiter/Waitress | Electro-mechanical |
| Locksmith | Emergency Medical | technician |
| Radiological Technician | Technician | Physical Therapist |
| Security Guard | Law enforcement officer | Assistant |

TABLE 11
Mostly Indoors/Light Work/Mostly with Co-Workers job examples

| | | |
|---|---|---|
| Plastics Machine | Bicycle Repairer | Greenhouse Worker |
| Operator | Pest Control Worker | Robotics Machine |
| Graphic Artist | Computer systems | Operator |
| Communications | analyst/network | Computer programmer/ |
| Equipment | analyst | software engineer |
| Mechanic | Data Entry Worker | Sign Shop Worker |
| Floral Designer | Chemical Plant | Order Clerk |
| Electronics Assembler | Worker | Packing/Filling |
| Computer Repairer | Secretary | Machine |
| Health Information | Motor Vehicle | Operator |
| Technician | Dispatcher | Pet Care Worker |
| Frame Shop Worker | Scientist | Software engineer |
| Network analyst | Mechanical engineer | Market research analyst |
| Network administrator | Civil engineer | Industrial engineer |
| Surveyor | Electro-mechanical | |
| | technician | |

TABLE 12
Mostly Indoors/Light Work/Interact with Public

| | | |
|---|---|---|
| Auto Parts Salesperson | Barber | Pharmacist Technician |
| Manicurist | Hair Stylist | Hotel Desk Clerk |
| Rental Clerk | Bank Teller | Customer Service |
| | Service Station | Representative |
| Retail Salesperson | Attendant | Theme park |
| Dental Assistant | Telemarketer | Teacher |
| Human Service Worker | Library Assistant | Lawyer |
| Paraeducator | Medical Assistant | Computer technician |
| Receptionist | Retail sales | Reporter |
| Airport Passenger | Accountant | Nurse |
| Assistant | School | Real Estate Agent |
| Theatre Worker | psychologist | |
| Physician | Professor | |

### Example 5

### College Choice Preference Assessment

Going beyond career preference assessment, the system described herein provided tools and resources to identify education opportunities. The user had an access to a system with a virtual college throughout a game that offered a wide variety of services and applications relevant to the game environment (e.g. maps, locations, transportation, etc.) and personal management (e.g. calendar, budget, etc.). In addition, as the user planed for his future, he also considered the financial requirements to obtain the skills necessary for a particular career, as well as the kind of lifestyle that a particular career might afford him. These considerations were implemented in the same game setting, allowing him to see a larger picture of how education and career choices might impact the kind of lifestyle he envisioned for his future while connecting the user to local recourses in his area that provided these services.

When the user determined that he wanted a career and a lifestyle that involve higher or continued education, a service was provided to link the user to colleges and universities that would be best suited to their career selection, physical location, and financial particulars. Table 13 summarizes the inputs for assessing college choice preferences. Additionally, the user was able to view admission requirements, deadlines and other practical details needed to make informed decisions about the future. Information about available financial aid programs, housing, facilities, activities, and campus visits was also provided.

Table 14 list variables assembling a life in a college. Before the college began, the user went out to purchase furniture in order to set up his dorm. On the first day in college, he attended an orientation and handled various administrative paperworks. Then, he registered courses and attended lectures given by professors. In the science classes, he conducted experiments in a lab. After the school hours, he enjoyed the life with peers. The exposure to the college life assessed the preferences to continuing advanced education and evaluated a suitable major in college.

TABLE 13
Inputs for college choice preference assessment.

| | | |
|---|---|---|
| Location | Academics | Financial aid |

| | distance from home | majors offered | deadline(s) |
|---|---|---|---|
| | weather preference | special requirements | required forms |
| Environment | | accreditation | % of student |
| | type of school (2-year | (recognized by | population receiving |
| | or 4-year) | regional or national | aid |
| | school setting (urban, | accrediting bodies as | scholarships |
| | rural) | meeting its | part-time |
| | location and size of | objectives) | employment |
| | nearest city | student-faculty ratio | opportunities |

| | | |
|---|---|---|
| co-ed, male, female | typical class size | Housing |

| | | |
|---|---|---|
| religious affiliation | Disability Services | residence hall |

| Size | | Center on Disability | requirements |
|---|---|---|---|
| | enrollment | Individual Services | availability |

| | | |
|---|---|---|
| physical size of | College expenses | types and sizes |

| | | |
|---|---|---|
| campus | tuition, room and | food plans |

| | | |
|---|---|---|
| Admission requirements | board | Activities |

| | | |
|---|---|---|
| deadline(s) | estimated total budget | clubs, organizations |
| test(s) required | application fee, | sororities/fraternities |
| average test scores, | deposits | athletics, intramurals |

| | | |
|---|---|---|
| GPA, rank | Facilities | other |

| | | |
|---|---|---|
| special requirements | academic | Campus visits |

| | |
|---|---|
| recreational | when to visit |
| other | special opportunities |

TABLE 14
College living games.

| Game Level | Game Level | Game Level |
|---|---|---|
| Application package | Accommodations | Campus Healthcare |
| Interview prep | Financial Aid | Food services |
| Study skills | Student union | Disability Services |
| Choosing the right college | Getting an ID | Clubs & organizations |
| Routines & structure | Orientation | Sports & exercise |
| Self-advocacy | Labs | Lectures |

### Example 6

### Experiencing an Employment Life

This example shows that a high school student played through a day in the life of the careers derived from the career preference assessment. Each game experience was designed to take 20-30 minutes to complete. The games comprised mini-games that included both daily living skills (with the aid of the Peer Virtual Mentors as needed) and career specific skills and vocabulary (with the aid of the Career Virtual Mentor as needed). In this embodiment, the student started the day with a morning routine. The student's avatar was lying in bed sleeping and the alarm went off. The student had a choice to get up, hit snooze, or smash the clock. Each choice was related to efficiency points. For instance, getting up led to 10 points, hitting snooze leads to another decision in 10 seconds, smashing the clock reduces the efficiency score by 100 points. An efficiency score icon at the top of the screen helped the student monitor his/her own efficiency.

Other tasks during the morning routine included brushing teeth, taking a shower, brushing hair, eating a healthy breakfast, choosing an appropriate outfit, feeding pets, putting pets out and letting them back in, packing lunch, shutting off lights and appliances, locking the door, etc. Efficiency points were based on achieving all objectives in the allotted time. A clock reminds the student how much time was left before they would be late for work. Once the morning routine was complete the student left the house “sandbox” and must navigate to the job site.

This transportation game presented the student with a virtual address of the job. The student must use a mapping application to figure out where the job was and then made an appropriate decision about how to get there. Choices included walking, bike, public transportation, and driving. Efficiency points were given for arriving on time with the least expense. At advanced levels of the transportation game, natural events such as traffic jams and long lines at the subway may occur.

Once the student reached the job site, he/she reached the Career Virtual Mentor, who described what would be happening on the day. The day's events related back to the opening scenario. The Career Virtual Mentor used industry standard vocabulary and performed tasks the student would be expected to complete on a regular basis. The student then must complete the tasks independently. Table 15 provides a sample list of tasks associated with various employments. Once tasks had been completed, the student was presented with an authentic problem to solve. For instance, if the student was working at a fast food restaurant, a customer could come up and start yelling that there was a hair in her hamburger. The student must then decide how to react. Scenarios could be replayed and the Career Virtual Mentor was accessible. However, the student lost efficiency points by asking for the Mentor's help during the independent work time. This part of the game took 10-15 minutes to play. The student had an opportunity to play through three of the careers multiple times with increasing levels of complexity as higher efficiency scores were obtained. Again, 80% was used as the default to level up. Each level included consistent vocabulary and skills, which were increased in complexity by level.

The final aspect of the game was the evening routine. During this mini-game the student prepared for the next day. Making healthy choices (e.g., dinner, shower, bath, brush teeth) along with preparation for morning (e.g., laying out clothes, setting alarm, preparing coffee). Each time the student played through a career, he received a virtual achievement award that highlighted the daily living and work skills he had demonstrated mastery of. The outcome evaluation was based on efficiency scores. The system also drafted a resume for the job including a description of the skills the student had demonstrated mastery of. The resume also included skills which the student still needed to improve in order to become competitive for the job and courses/job training opportunities the student could select to further develop the skills. The Career Virtual Mentor provided positive reinforcement and offered suggestions for next time. The final outcome was an individualized learning plan that strategically aligned the student's coursework and career path.

TABLE 15
Daily living skills games.

| Game | Game Level | Game | Game Level | Game | Game Level |
|---|---|---|---|---|---|
| Morning | Energy | Community | Finding community | Healthy Living & | Run |
| Routine | Conservation | | events & resources | Exercise | Bike |
| | Bathroom | | Financial mgt. | | Swim |
| | Kitchen | | Volunteer work | | Soccer |
| | Pet(s) | | Voting | | Softball |
| | What to wear | | Local sports team | | Gym w/weightlift |
| | Bedroom | | Town hall | | Drugs and alcohol |
| | Safety | | Religion | | Smoking |
| Evening | Kitchen | | Shopping | Health Care | Influenza |
| Routine | Bathroom | Crisis | Leaking pipe | | Stomach flu |
| | Energy | | Fire | | Scrapes and cuts |
| | Conservation | | Flood | | Headache |
| | Pet(s) | | Car accident | | Medication |
| | Bedroom | | Tornado | | When to call 911 |
| | Safety | | Power outage | | Intimacy |
| Assistive | Text-to-speech | Living | Apartment | | Clean it up! |
| technology | Speech-to-text | | Duplex | | Laundry |
| | Google maps | | Community | | Medicare |
| | Weather | | Dorm room | Communication | Active listening |
| | News | | Farm house | | Asking questions |
| | Traffic | | Assisted Living | | Facial expressions |
| | iTranslate | Leisure | Sports | | Body language |
| Transportation | Using a map/GPS | | Movies | | After the interview |
| | Walk | | Dinner out | | Self-advocacy |
| | Skateboard | | Dating | Recruiter | Headhunter |
| | Bike | | Gardening | | Classifieds |
| | Bus | | Theater | | Monster.com |
| | Subway | | Museum | | Link to local jobs |
| | Taxi | | Keg Party! | | Resume review |
| | Drive | | Gardening | | |
| | Truck | | | | |

### Example 7

### Context-Sensitive Verbal and Non-Verbal Tracking and Analysis

This example shows how a job seeker exploited a system to improve interview skills. Once a career preference assessment had been concluded, the system can identify potential employers suitable for the job seeker. The system generated a simulated environment of conducting an interview. In addition to interview based questions-and-answers, which evaluated the verbal skills, the system also utilized tracking devices to record the gestures, postures, and facial expressions of the interviewee to evaluate body languages. By registering and recognizing body languages in a known context, the simulation provided a detailed after-action review as well as real-time responses. Through the review session, the job seeker was able to identify inappropriate verbal wordings and nonverbal actions. The problem identification process allowed the job seeker to practice more suitable responses.

### Example 8

### Monitoring Application

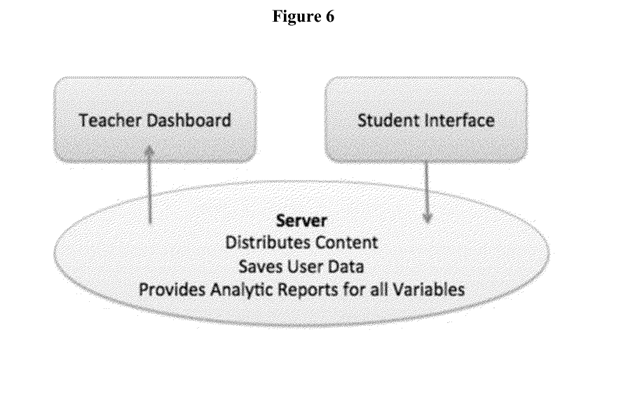

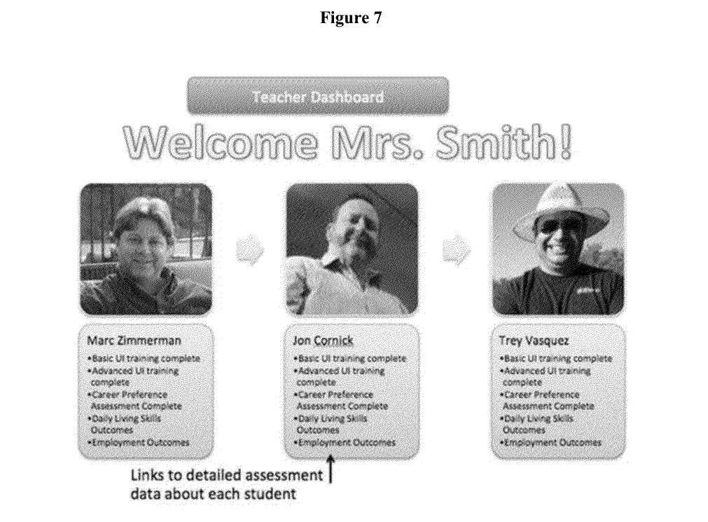

FIG. 6 shows a building block of a system underlying the assessment application and monitoring application. The server provided an assessment application to a student, who performed various actions in virtual tasks. The responses were collected and stored in a server. The server further provided a monitoring application, called Teacher Dashboard in this example, to a teacher who can review the career preference, college choice, assessment report, and/or learning progress of the student. A teacher dashboard is shown in FIG. 7. Through the dashboard, the teach “Mrs. Smith” was able to review the learning progress of her students.

### Example 9

### System Features

The system described in this application utilized games, or video games, to simulate the scenarios of employment days, college life, and interviews. The functional features of the whole system are listed in Tables 16-23, including general setting, navigation, user interface, game play, supporting metacognition, share cognitive load, communication, and employment. The aggregate of these features maximized the accessibility of the games while engaging students in meaningful activities that led to sustainable learning outcomes.

TABLE 16
General features of the system.

Offer a choice of difficulty levels (settings or dynamic)
Offer choice of game speed (settings or dynamic)
Auto save game progress every 3 minutes
Auto save when closing or quitting
Manual save progress option
Allow settings to be saved to different profiles by either user
level 1 or level 2
Offer a means to bypass gameplay elements that aren't part of the
core mechanic via settings or in game skip option
Include assist modes such as auto aim during virtual movement
(click to final destination)
Allow a preference to be set for playing online multiplayer with/
without others who are using accessibility features that could
give a competitive advantage
Provide a choice of text color low/high contrast
Provide native voice read for all text including menu and installers
Provide an option to turn off/hide all non interactive elements
Allow students to select perspective (1st vs. 3rd)
Allow student to select career specific virtual mentor(s) and a
personal learning assistant (big brother/big sister) for daily
living skills
Utilize camera on computer or mobile device to recognize facial and
kinesthetic expressions during gameplay
Auto-populate school data from Zip Code
Provide details on accessibility features on website
Include every relevant category of impairment (motor, cognitive
etc.) amongst play-testing participants, in representative numbers
based on age/demographic of target audience aligning with W3C standards
as much as possible and still have a visually and useable interface

TABLE 17
Navigation features of the system.

Allow controls to be remapped/reconfigured
Ensure that all areas of the user interface can be accessed using
the same input method as the gameplay
Include an option to adjust the sensitivity of controls
Ensure controls are as simple as possible
Ensure interactive elements/virtual controls are large and well
spaced, particularly on small screens
Allow teleporting to travel within the game (except when navigation
is the objective)
Support more than one input device
Make interactive elements that require accuracy (e.g. cursor/touch
controlled menu options) stationary
Ensure that all key actions can be carried out by digital controls
(pad/keys/presses) with more complex input (e.g., Analogue, speech,
gesture) not required, and included only as supplementary/alternative
input methods
Avoid repeated inputs (button-mashing/quick time events)
Do not make precise timing essential to gameplay-offer alternatives,
actions that can be carried out while paused or a skip mechanism
Include a cool down period (post acceptance delay) of .5 seconds
between inputs
Provide control schemes that are compatible with assistive technology
devices such as switch or eye
tracking

TABLE 18
User interface features of the system.

Allow customizable toolbar location
Allow the game to be started without the need to navigate through
multiple levels of menus
Use an easily readable default font size
Use simple clear language
Use simple text formatting that is compatible with screen readers
Include tutorials via Personal Learning Assistant and Career
Virtual Mentor

TABLE 19
Game play features of the system.

Use step/pause/replay to allow progression at the players own pace
through narrative or instruction
Include contextual in game help guidance tips
Allow reminder of current objectives during gameplay if students
become distracted or forget directions
Include a map when using complex environments
Employ a simple clear narrative structure
Provide opportunities to replay all levels without penalty until
success
Provide summaries of progress in the game
Ensure no essential information (especially instructions) is
conveyed by text alone, reinforce with visuals and/or audio
Give a clear indication that interactive elements are interactive
Provide an option to turn off/hide background movement
Support voice chat as well as text for multiplayer game features
Provide gameplay thumbnails with game saves
Provide separate volume controls or mutes for effects, speech and
background music
Ensure sound/music choices for each key objects events are distinct
from each other
Use symbol based directions & text chat options
Built-in technology tips throughout (e.g., Hey Billy, did you know
there is an app on your phone that can do that for you? Take a
look - show demo).

TABLE 20
Supporting metacognition features of the system.

Basic training (game mechanics proficiency 80% minimum)
Advanced training game mechanics proficiency 80% minimum)
Prior knowledge assessment
Visual dictionary
Policy link in resource room (international/federal/state/local)
Virtual resource room
Mission database
Mission briefings (opening scenario)
Game progress summaries
Cookies
Post mission debrief/reflection
FAQ
Advanced procedure guide / task analysis (graphic organizer, text, audio)
Help option - talking head (avatar vs. human vs. audio vs. text)

TABLE 21
Share cognitive load features of the system.

Location map
Screen capture camera
Scientific calculator (manual vs. automatic)
Field journal (manual or automatically populated)
Picture in picture allows user to see events in another location
Progress monitor (cookies)
Provide game clock and efficiency meter

TABLE 22
Communication features of the system.

Provide dropdown box with people in same school or similar
feature across schools
Peers/Teachers/Industry communication
Allow student to chose how they communicate (text, voice, video)
Provide synchronous and asynchronous communication opportunities
with industry personnel

TABLE 23
Employment features of the system.

Individual learning plan (ILP)
Descriptions of what each industry looks for in a job candidate
Examples and non-examples of interview techniques
Projected job numbers, training, salary, benefits
Sample resume
Resume builder based on content mastery (badges)

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. Non-transitory computer-readable storage media encoded with a computer program including instructions executable by a processor to create an assessment application comprising:
a. a first software module configured to evaluate an aptitude or a preference of a first user;
b. a second software module configured to interact with the first user in a setting of a virtual task; and
c. a third software module configured to record and evaluate one or more of the interactions with the second software module.

2. The media of claim 1, wherein the virtual task is determined based on the aptitude or the preference of the first user and is designed to prepare the first user for an employment.

3. The media of claim 1, wherein the virtual task is implemented by a video game.

4. The media of claim 1, wherein the assessment application further comprises a software module configured to record the interactions and analyze appropriateness of the interactions performed by the first user in the virtual task.

5. The media of claim 1, wherein the assessment application further comprises a software module configured to evaluate a college choice for the first user.

6. The media of claim 1, wherein the assessment application further comprises a software module configured to generate an assessment report to the first user.

7. The media of claim 1, wherein the assessment application further comprises a software module configured to draft a resume on behalf of the first user.

8. The media of claim 1, wherein the assessment application further comprises a software module configured to suggest to the first user one or more of the following: a career path, one or more educational institutions, and one or more employment opportunities.

9. The media of claim 1, wherein the assessment application further comprises a software module configured to provide the first user with a learning platform.

10. The media of claim 9, wherein the learning platform comprises one or more instructions teaching the first user with one or more skills to complete a virtual task.

11. The media of claim 10, wherein the learning platform comprises an exam to evaluate the one or more skills learned by the first user.

12. The media of claim 1 further comprising a monitoring application for a second user, wherein the monitoring application allows the second user to review one or more of the following: the aptitude of the first user, the preference of the first user, one or more interactions of the first user in a virtual task, and a learning progress of the first user.

13. The media of claim 12, wherein the assessment application is a software as a service, the monitoring application is a software as a service, or a combination of the assessment application and the monitoring application is a software as a service.

14. A computer-implemented system comprising:
a. a digital processing device comprising an operating system configured to perform executable instructions and a memory device;
b. a computer program including instructions executable by the digital processing device to create an assessment application comprising:
i. a first software module configured to evaluate an aptitude or a preference of a first user;
ii. a second software module configured to interact with the first user in a setting of a virtual task;
iii. a third software module configured to evaluate one or more of the interactions; and
iv. a fourth software module configured to generate an assessment report.

15. The system of claim 14, wherein the assessment application further comprises a software module configured to evaluate a college choice for the first user.

16. The system of claim 14, wherein the assessment application further comprises a software module configured to draft a resume on behalf of the first user.

17. The system of claim 14, wherein the assessment application further comprises a software module configured to suggest to the first user one or more of the following: a career path, one or more educational institutions, and one or more employment opportunities.

18. The system of claim 14, wherein the assessment application further comprises a software module configured to provide the first user with a learning platform.

19. The system of claim 14 further comprising a monitoring application for a second user, wherein the monitoring application allows the second user to review one or more of the following: the aptitude of the first user, the preference of the first user, one or more interactions of the first user in a virtual task, and learning progress of the first user.

20. A network comprising:
a. a first computer terminal configured to provide an assessment application comprising:
i. a software module configured to evaluate an aptitude or a preference of a first user;
ii. a software module configured to interact with the first user in a setting of a virtual task;
iii. a software module configured to evaluate one or more of the interactions;
b. a second computer terminal configured to provide a monitoring application comprising:
i. a software module configured to review the aptitude or the preference of the first user.
ii. a software module configured to review the one or more interactions of the first user;
iii. a software module configured to review a learning progress report of the first user;
c. a server comprising a processor configured to provide a server application comprising:
i. software module configured to store the aptitude or the preference of the first user;
ii. software module configured to prepare the virtual task;
iii. software module configured to offer a learning platform for the first user;
iv. software module configured to record the learning progress of the first user;
d. one or more network connections between the server and the first and the second computer terminals.
